(19) United States
(12) Patent Application Publication
(10) Pub. No.: US 2023/0384552 A1
(43) Pub. Date: Nov. 30, 2023

(54) IMAGING APPARATUS

(71) Applicant: CANON KABUSHIKI KAISHA, Tokyo (JP)

(72) Inventor: YUTA YASUTAKE, Tokyo (JP)

(21) Appl. No.: 18/322,468

(22) Filed: May 23, 2023

(30) Foreign Application Priority Data
May 30, 2022 (JP) 2022-087974

(51) Int. Cl. G02B 7/00; G02B 7/02; H02K 7/116; H02K 37/24

(52) U.S. Cl. CPC G02B 7/005; H02K 37/24; H02K 7/1166; G02B 7/021

(57) ABSTRACT

An imaging apparatus includes an imaging unit configured to have a lens barrel that is capable of pivot rotation about an optical axis by a drive mechanism for rotation, a cover configured to cover the imaging unit, a light-shielding member configured to contact an inner surface of the cover, and an illumination device configured to be disposed in a space covered with the cover, wherein the light-shielding member is capable of retracting in a direction away from the cover by the drive mechanism.

### BACKGROUND

### Field

The present disclosure generally relates to an imaging apparatus, more particularly to an imaging apparatus capable of an imaging direction adjustment using an electrically driven motor.

### Description of the Related Art

In recent years, there has been growing demand for imaging apparatuses equipped with an illumination device, to capture a clear video image even in darkness. Some of these imaging apparatuses have an illumination device disposed in a space where a lens barrel is disposed.

In a case of disposing the illumination device together with the lens barrel in the same space, a light-shielding member may be provided between the lens barrel and the illumination device to prevent illumination light to be in an image. It is desirable that the light-shielding member is provided in close contact with the inner surface of a protective cover. For example, Japanese Patent No. 6195081 discusses a structure in which a light-shielding member made of rubber is disposed between a lens barrel and a light-emitting diode (LED) for emission of infrared light, and the light-shielding member is pressed by a protective cover. Accordingly, the light-shielding member is brought in close contact with the inner surface of the protective cover.

According to the structure discussed in Japanese Patent No. 6195081, in a case of an imaging apparatus of which imaging direction can be remotely adjusted using an electrically driven motor, the friction between the protective cover and the light-shielding member results in a heavy load on the adjustment. As a solution to this issue, the light-shielding member may be retracted in a direction away from the protective cover at the time of the imaging direction adjustment using an electrically driven motor. However, an actuator that is separately provided to retract the light-shielding member in the direction away from the protective cover may cause upsizing of the main body of the imaging apparatus.

### SUMMARY

The present disclosure is directed to providing an imaging apparatus, including a lens barrel and being capable of an imaging direction adjustment using an electrically driven motor, in which a light-shielding member retractable in a direction away from a protective cover is provided without upsizing of the imaging apparatus.

According to some embodiments, an imaging apparatus includes an imaging unit configured to have a lens barrel that is capable of rotation about an optical axis by a drive mechanism for rotation, a cover configured to cover the imaging unit, a light-shielding member configured to contact an inner surface of the cover; and an illumination device configured to be disposed in a space covered with the cover, wherein the light-shielding member is capable of retracting in a direction away from the cover by the drive mechanism.

Further features of the present disclosure will become apparent from the following description of exemplary embodiments with reference to the attached drawings.

### BRIEF DESCRIPTION OF THE DRAWINGS

FIG. 1 is an exploded perspective view of an imaging apparatus according to a first exemplary embodiment.

FIG. 2 is a perspective view of an imaging unit according to the first exemplary embodiment.

FIG. 3 is an exploded perspective view of the imaging unit according to the first exemplary embodiment.

FIG. 4 is an exploded perspective view of a tilt unit according to the first exemplary embodiment.

FIGS. 5A to 5D are diagrams illustrating a positional relationship between a lock member and a lens barrel up to a state where a retraction mechanism of a light-shielding unit according to the first exemplary embodiment is locked.

FIGS. 6A and 6B are diagrams illustrating a method for locking the retraction mechanism of the light-shielding unit according to the first exemplary embodiment.

FIGS. 7A to 7C are diagrams illustrating a positional relationship between the lock member and the lens barrel up to a state where the retraction mechanism of the light-shielding unit according to the first exemplary embodiment is unlocked.

FIGS. 8A and 8B are diagrams illustrating a method for unlocking the retraction mechanism of the light-shielding unit according to the first exemplary embodiment.

FIG. 9 is an exploded perspective view of an imaging apparatus according to a second exemplary embodiment.

FIG. 10 is an exploded perspective view of an imaging unit according to the second exemplary embodiment.

FIG. 11 is a flowchart of a procedure of retraction/close contact of the light-shielding member from/with the protective cover.

### DESCRIPTION OF THE EMBODIMENTS

Hereinafter, preferred exemplary embodiments of the present disclosure will be described in detail with reference to the accompanying drawings. However, the dimensions, materials, relative positions of constituent elements in the following exemplary embodiments can be arbitrarily set and can be changed in accordance with the configuration of the apparatus to which the present invention is applied or on various conditions. Description of cables and parts having no direct relation with the present disclosure will be omitted and these parts are not illustrated in the drawings. The shapes of some components may be described in a simplified manner for the convenience of description.

In a first exemplary embodiment, an example of an exemplary embodiment of an imaging apparatus to which the present disclosure is applied will be described.

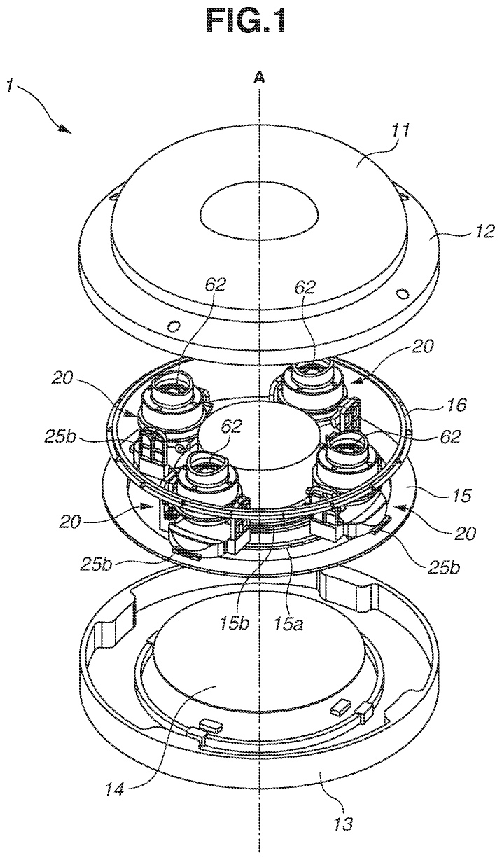

FIG. 1 is an exploded perspective view of an imaging apparatus 1. The imaging apparatus 1 includes a protective cover 11, a housing including a top case 12 and a bottom case 13, a control circuit board 14, a base member 15, four imaging units 20, and an imaging unit holder 16.

The protective cover 11 protects the four imaging units 20 from, for example, rain drops, dust, and external impact.

The protective cover 11 is a transparent member, such as polycarbonate and the like, and thus, the four imaging units 20 can capture images from inside. The protective cover 11 is fixed to the top case 12.

The control circuit board 14 is a circuit board for controlling the four imaging units 20 and the like. The control circuit board 14 has an image processing engine that processes imaging signals from the four imaging units 20, and a motor driver that generates drive signals to three motors for shift movement, tilt rotation, and pivot rotation included in each of the four imaging units 20.

The control circuit board 14 is fixed to the bottom case 13 and connected to the four imaging units 20 via cables not illustrated. While, in the present exemplary embodiment, the control circuit board 14 has a circular shape, the shape is not limited to circular and can be rectangular or another shape.

The base member 15 supports the imaging units 20. The base member 15 has a spur gear 15a and is fixed to the bottom case 13.

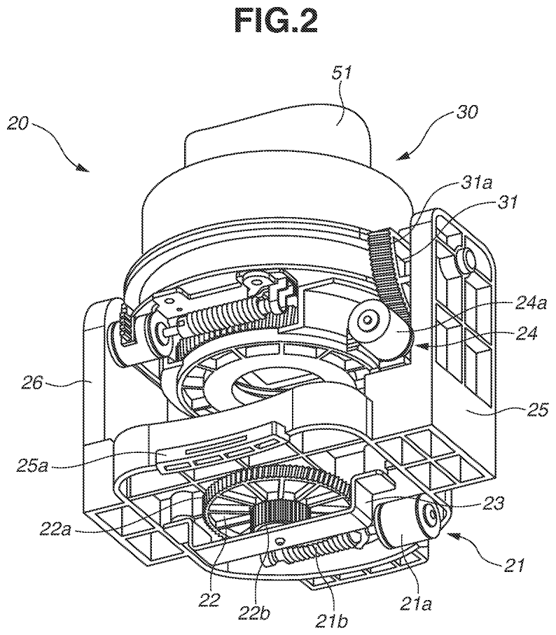

Each of the four imaging units 20 includes a lens barrel 62 that has a lens group (not illustrated) and an imaging element (not illustrated). In each of the four imaging units 20, a first protrusion part 25a, which is described below and illustrated in FIG. 2, is engaged with a groove part 15b of the base member 15, and a second protrusion part 25b is held between the base member 15 and the imaging unit holder 16. The imaging units 20 supports the respective lens barrels 62 in such a manner that the lens barrels 62 can be rotated in pivot and tilt directions, and the imaging units 20 are capable of shift movement on the base member 15. The pivot rotation here refers to a rotation about an optical axis of the lens barrel 62. The tilt rotation here refers to a vertical rotation about an axis substantially orthogonal to the optical axis. That is, the tilt rotation is a rotation about a predetermined axis (tilt axis) different from the optical axis of the lens barrel 62. The shift movement is a movement in a circumferential direction around a central axis A of the imaging apparatus 1. That is, the shift movement is a movement around a predetermined axis (axis A) different from the optical axis of the lens barrel 62. The four imaging units 20 are arranged in circle. While, in the present exemplary embodiment, a plurality of the imaging units 20 is provided, the number of the imaging units 20 can be one.

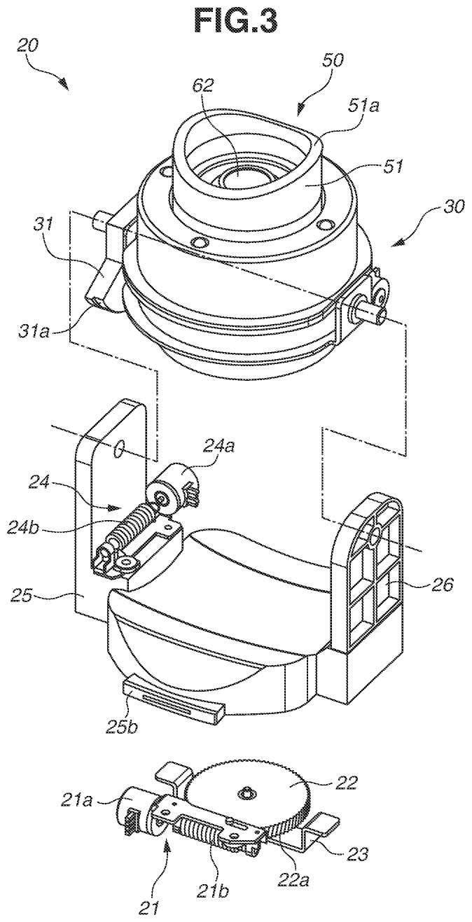

FIG. 2 is a perspective view of one imaging unit 20. FIG. 3 is an exploded perspective view of one imaging unit 20. The imaging unit 20 includes a tilt unit 30, a shift motor unit 21, and a tilt motor unit 24. As used herein, the term “unit” generally refers to any combination of hardware, firmware, software, or other component that is used to effectuate a purpose, and may comprise one or more processors, circuitry, or combinations thereof.

The tilt unit 30 has a lens group (not-illustrate) and an imaging element (not illustrated), and includes the lens barrel 62 fixed to a lens barrel holder 61 and a tilt gear 31. The tilt unit 30 is supported by a shift base formed of a first shift base 25 and a second shift base 26 to be capable of tilt rotation. The first shift base 25 has the first protrusion part 25a and the second protrusion part 25b. The first protrusion part 25a and the second protrusion part 25b protrude in a radial direction of the lens.

The tilt motor unit 24 is a drive mechanism for tilt rotation. The tilt motor unit 24 includes a stepping motor 24a and a worm gear 24b, and is fixed to the first shift base 25. The worm gear 24b is press-fitted to an output shaft of the stepping motor 24a.

When the worm gear 24b and a helical gear 31a of the tilt gear 31 engage with each other, the lens barrel 62 is moved with tilt rotation.

The shift motor unit 21 is a drive mechanism for shift movement. The shift motor unit 21 includes a stepping motor 21a and a worm gear 21b, and is fixed to the first shift base 25. The worm gear 21b is press-fitted to an output shaft of the stepping motor 21a.

A shift gear holder 23 is fixed to the first shift base 25, and a shift gear 22 is rotatably supported by the first shift base 25 and the shift gear holder 23. When the worm gear 21b and a helical gear 22a of the shift gear 22 engage with each other and a spur gear 22b of the shift gear 22 and the spur gear 15a of the base member 15 engage with each other, the imaging unit 20 is moved with shift movement by the stepping motor 21a serving as a movement power source.

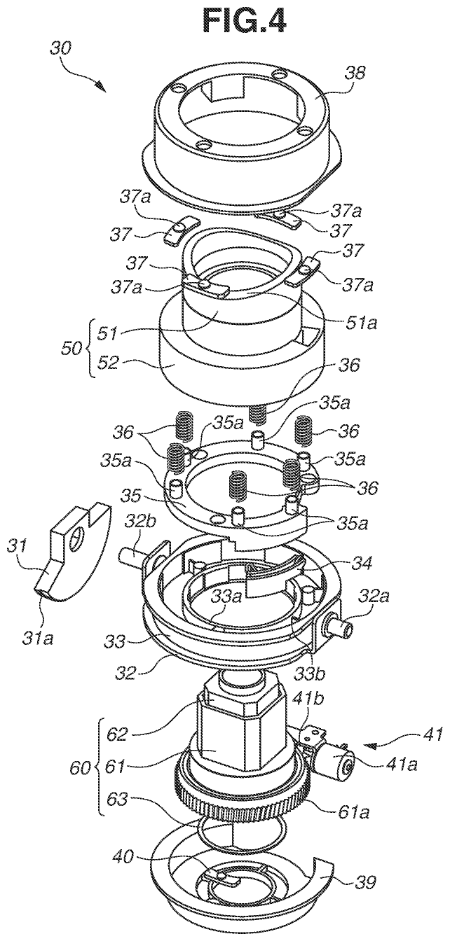

FIG. 4 is an exploded perspective view of the tilt unit 30. The tilt unit 30 further includes a rotation unit 60, a light-shielding unit 50, and infrared illumination devices 37a.

The rotation unit 60 includes the lens barrel holder 61, the lens barrel 62, and a rotation scale 63. The rotation unit 60 is rotatably supported by a tilt base that includes a first tilt base 32 and a second tilt base 33, and a rotation unit holder 39.

A rotation motor unit 41 is a drive mechanism for pivot rotation (rotation drive mechanism).

The rotation motor unit 41 includes a stepping motor 41a and a worm gear 41b, and is fixed to the first tilt base 32. The worm gear 41b is press-fitted to an output shaft of the stepping motor 41a. When the worm gear 41b and a helical gear 61a of the lens barrel holder 61 engage with each other, the lens barrel 62 is moved with pivot rotation by the stepping motor 41a serving as a movement power source.

The rotation unit holder 39 is fixed to the first tilt base 32 and holds the lens barrel holder 61 with the tilt base including the first tilt base 32 and the second tilt base 33.

An encoder circuit board 40 is fixed to the rotation unit holder 39. The encoder circuit board 40 has a light-emitting element and a light-receiving element to detect a rotation phase (rotation angle) of the rotation unit 60. The light-emitting element and the light-receiving element can be smart rubber (SR) sensors, for example. The light-emitting element and the light-receiving element are an example of a detection unit.

The lens barrel 62 has a lens group (not illustrated) and an imaging element (not illustrated), and is fixed to the lens barrel holder 61. The rotation scale 63 is attached to the lens barrel holder 61. The rotation scale 63 has a pattern formed with a predetermined pitch and functions as an optical rotary scale. A light flux emitted from the light-emitting element of the encoder circuit board 40 is reflected by the rotation scale 63, and the reflected light flux is received by the light-receiving element, whereby an output signal is obtained and the rotation phase of the rotation unit 60 can be detected.

The first tilt base 32 includes a first tilt shaft 32a and a second tilt shaft 32b. The second tilt base 33 is fixed to the first tilt base 32. The tilt gear 31 is fixed to the first tilt base 32.

A lock member 34 is disposed between a first rib 33a and a second rib 33b of the second tilt base 33, and is movable about the optical axis of the lens barrel 62. A coil spring holder 35 has six guide poles 35a and is fixed to the second tilt base 33, and the lock member 34 is held between the second tilt base 33 and the coil spring holder 35. Coil springs 36 are arranged around the guide poles 35a to bias the light-shielding unit 50 toward the protective cover 11.

The light-shielding unit 50 suppresses the intrusion of the infrared light that is emitted by the infrared illumination devices 37a and reflected by the protective cover 11 into the lens barrel 62. The light-shielding unit 50 includes a light-shielding member 51 and a light-shielding member holder 52. The light-shielding member 51 formed of an elastic member, such as rubber or thermoplastic elastomer, has a substantially annular shape, and is fixed to or integrated with the light-shielding member holder 52.

The infrared illumination devices 37a are light emitting diodes (LED) that emit infrared light, and are used to capture a clear video image even in a low-light situation, such as in darkness environment. The infrared illumination devices 37a are arranged outside the light-shielding member 51 in a space covered with the protective cover 11. A light-shielding unit stopper 38 has four through-holes through which the infrared illumination devices 37a irradiate a subject with infrared light.

Each of the infrared illumination devices 37a is mounted on a different one of four infrared illumination circuit boards 37. The four infrared illumination circuit boards 37 are fixed to the light-shielding unit stopper 38.

In a state in which the protective cover 11 is not attached, the light-shielding unit 50 is biased by the compressed coil springs 36 toward an attachment direction of the protective cover 11. In this state, the light-shielding unit 50 is in contact with the light-shielding unit stopper 38. When the protective cover 11 is attached to the light-shielding unit 50, the light-shielding unit 50 sinks in a direction in which the coil springs 36 are further compressed. The light-shielding unit 50 is then biased toward the protective cover 11. Accordingly, a close-contact surface 51a of the light-shielding member 51 comes in close contact with the inner surface of the protective cover 11. Accordingly, the direct infrared light emitted from the infrared illumination devices 37a and the reflection of the infrared light from the protective cover 11 are blocked and does not reach the lens barrel 62.

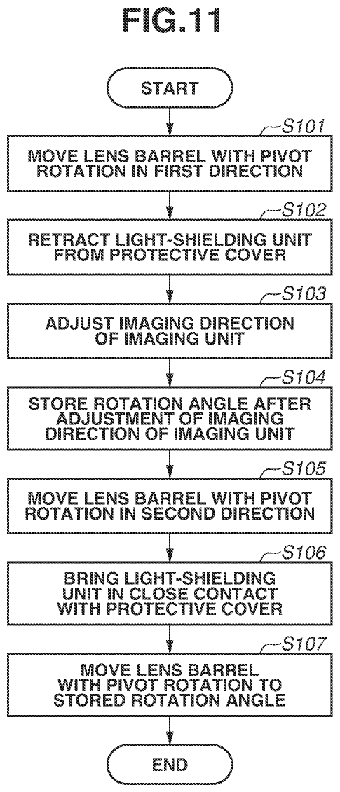

Next, a procedure of retraction/close contact of the light-shielding member 51 from/with the protective cover 11 and the imaging direction adjustment of the imaging unit 20 will be described with reference to FIG. 11. FIG. 11 is a flowchart for describing a procedure of retraction/close contact of the light-shielding member 51 from/with the protective cover 11. The process in the flowchart is executed in a case of changing the imaging direction of each imaging unit 20. First, in step S101, the lens barrel 62 of the imaging unit 20 is moved with pivot rotation in a first direction. When the lens barrel 62 rotates at a certain angle or more, in step S102, the light-shielding unit 50 retracts from the protective cover 11. After that, in step S103, the imaging direction of the imaging unit 20 is adjusted (changed) to a desired direction. Upon completion of the adjustment, in step S104, the rotation angle after the imaging direction adjustment of the imaging unit 20 is stored in a memory not illustrated. Subsequently, in step S105, the lens barrel 62 rotates in a second direction opposite to the first direction. When the lens barrel 62 is moved with pivot rotation at a certain angle or more, in step S106, the light-shielding unit 50 comes in close contact with the protective cover 11. After that, in step S107, the lens barrel 62 is rotated at the rotation angle stored in step S104. Subsequently, the details of this process will be described.

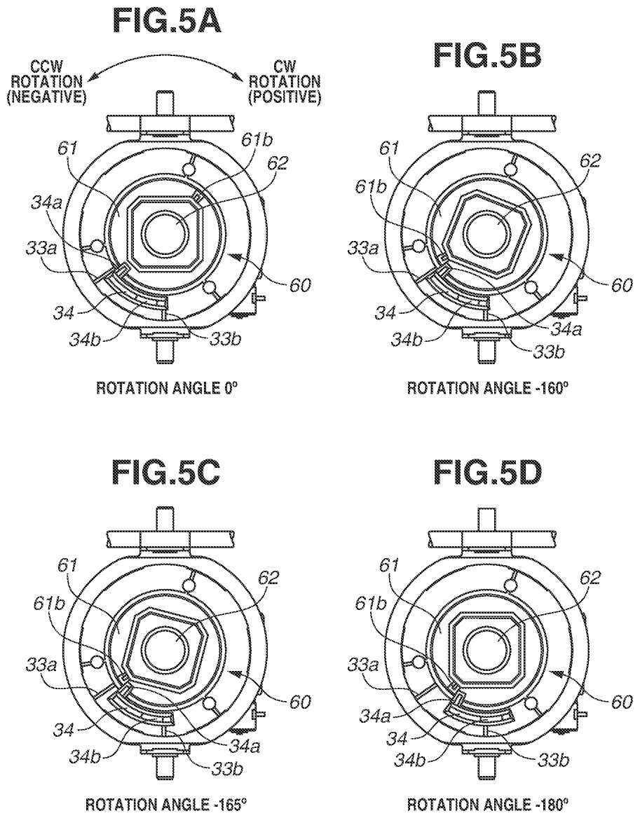

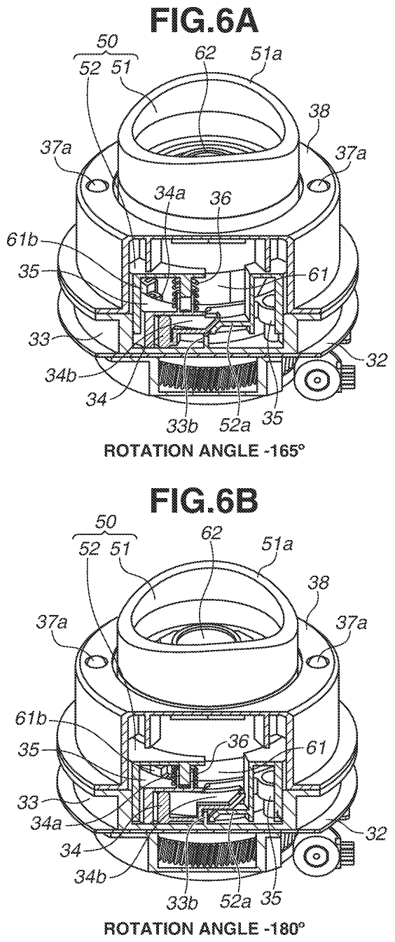

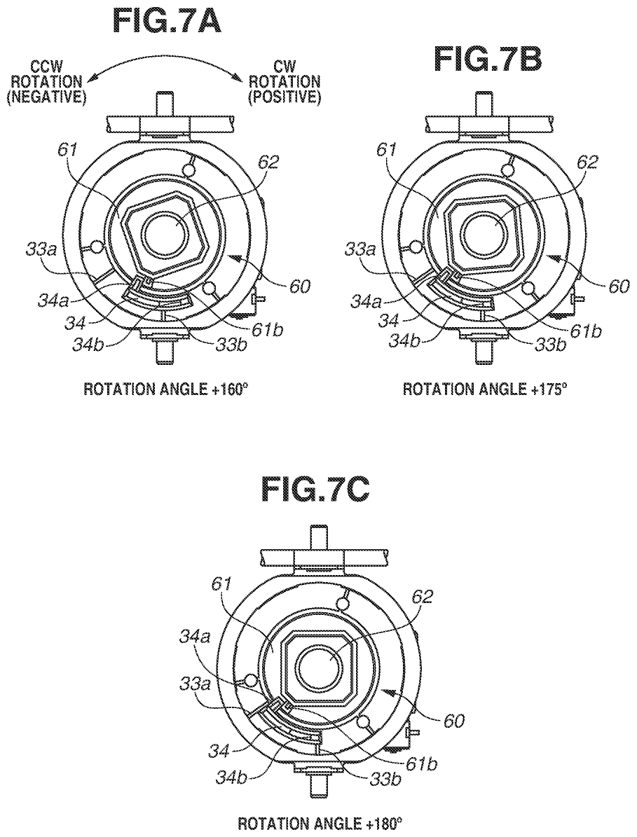

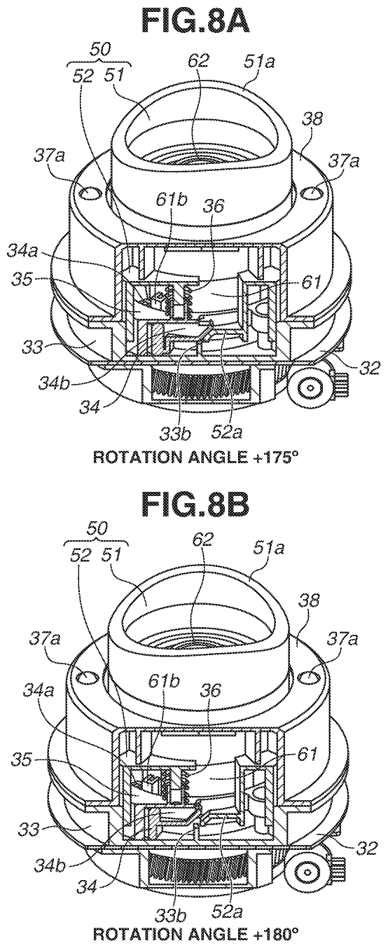

FIGS. 5A to 5D are diagrams describing a positional relationship between the lock member 34 and the lens barrel 62 up to a state in which a retraction mechanism of the light-shielding unit 50 is locked. FIGS. 6A and 6B are diagrams describing a method for locking the retraction mechanism of the light-shielding unit 50. FIGS. 7A to 7C are diagrams describing the positional relationship between the lock member 34 and the lens barrel 62 up to a state in which the retraction mechanism of the light-shielding unit 50 is unlocked. FIGS. 8A and 8B are diagrams describing a method for unlocking the retraction mechanism of the light-shielding unit 50.

For the convenience of description of the positional relationship between the lock member 34 and the lens barrel 62, FIGS. 5A to 5D and 7A to 7C illustrate components related to the description. FIGS. 6A, 6B, 8A, and 8B are perspective cross-sectional views for description of the positional relationship between the lock member 34 and the light-shielding member holder 52. The definitions of a clockwise (CW) direction and a counter clockwise (CCW) direction of pivot rotation and positive and negative rotation angles are as illustrated in FIGS. 5A to 5D and 7A to 7C.

At the time of pivot rotation, a convex part 34a of the lock member 34 is pressed against a convex part 61b of the lens barrel holder 61, and thus the lock member 34 is movable about the optical axis of the lens barrel 62 between the first rib 33a and second rib 33b of the second tilt base 33. In the present exemplary embodiment, the movable range of the lock member 34 is 20 degrees)(° as an example. The operable range of rotation for locking and unlocking the retraction mechanism of the light-shielding unit 50 is −180° to +180° as an example.

Further, as a range not for the retraction of the light-shielding unit 50, the preset range of pivot rotation settable at the time of the imaging direction adjustment is −160° to +160° as an example. That is, the rotation angles other than ˜160° to +160° are out of the range of pivot rotation at the time of the imaging direction adjustment. The drive signal from the stepping motor 41a for rotation is controlled based on a rotation phase detected by the encoder circuit board 40 and the rotation scale 63, whereby the lens barrel 62 is rotated at a designated rotation angle.

The operable range of pivot rotation for locking and unlocking the retraction mechanism of the light-shielding unit 50 and the settable range of rotation angles at the time of the imaging direction adjustment are controlled by firmware.

Herein, a case of adjusting the imaging direction from an initial state of the lens barrel 62 at a rotation angle of 0° will be described as an example. First, in a case of retracting the light-shielding unit 50, the lens barrel 62 is moved with pivot rotation in the CCW direction up to a rotation angle of −180° that is at the negative end of the operable range of pivot rotation.

More specifically, the lens barrel 62 rotates in the CCW direction from the initial state at a rotation angle of 0° illustrated in FIG. 5A. Then, the convex part 61b of the lens barrel holder 61 abuts on the convex part 34a of the lock member 34 at a rotation angle of −160° illustrated in FIG. 5B.

In a case where the lens barrel 62 is moved further with pivot rotation in the CCW direction from the state illustrated in FIG. 5B, the lock member 34 slides in the CCW direction. At a rotation angle of −165° illustrated in FIG. 5C, an oblique surface of a lock part 34b of the lock member 34 abuts on an oblique surface of a locked part 52a of the light-shielding member holder 52 as illustrated in FIG. 6A.

From the state illustrated in FIG. 6A, the lens barrel 62 is moved further with pivot rotation in the CCW direction. The lock part 34b of the lock member 34 thus presses downward the locked part 52a of the light-shielding member holder 52. This causes the light-shielding unit 50 to retract downward along a part fitting with the second tilt base 33. Then, at a rotation angle of −180° illustrated in FIG. 5D, the lock member 34 stops at a position where the lock member 34 abuts on the second rib 33b of the second tilt base 33 as illustrated in FIG. 6B. The lock part 34b of the lock member 34 engages with the locked part 52a of the light-shielding member holder 52 and shifts to a locked state, that is, the light-shielding unit 50 is kept retracted in the direction away from the protective cover 11.

Thus, the light-shielding unit 50 is kept retracted downward even when the light-shielding unit 50 is moved with pivot rotation in the CW direction, and a gap appears between the close-contact surface 51a of the light-shielding member 51 and the protective cover 11. Consequently, the light-shielding unit 50 can retract in the direction away from the protective cover 11 with the stepping motor 41a for pivot rotation serving as a movement power source.

In the state where the light-shielding unit 50 is retracted downward, no friction is generated between the light-shielding member 51 and the protective cover 11 at the time of shift movement, tilt rotation, or pivot rotation. Thus, the imaging units 20 can be moved with shift movement, tilt rotation, or pivot rotation using the electrically driven motor in the imaging direction adjustment without any friction between the light-shielding member 51 and the protective cover 11. Upon completion of the imaging direction adjustment, the rotation angle after the adjustment is stored in the firmware (storage unit).

Next, in a case of returning the light-shielding unit 50 retracted downward to the original position, the lens barrel 62 is moved with pivot rotation at a rotation angle of +180° in the CW direction.

More specifically, the lens barrel 62 rotates from the state after completion of the imaging direction adjustment. Then, at a rotation angle of +160° illustrated in FIG. 7A, the convex part 61b of the lens barrel holder 61 abuts on the convex part 34a of the lock member 34.

In a case where the lens barrel 62 is moved further with pivot rotation in the CW direction from the state illustrated in FIG. 7A, the lock member 34 moves in the CW direction. Then, the oblique surface of the lock part 34b of the lock member 34 starts to abut on the oblique surface of the locked part 52a of the light-shielding member holder 52. The light-shielding member holder 52 starts to be pressed and returned by the coil springs 36 toward the protective cover 11 along the part fitting with the second tilt base 33. Then, at a rotation angle of +175° illustrated in FIG. 7B, the lock part 34b of the lock member 34 and the locked part 52a of the light-shielding member holder 52 are disengaged from each other as illustrated in FIG. 8A. The light-shielding unit 50 thus returns to the original position, and the close-contact surface 51a of the light-shielding member 51 comes in close contact with the inner surface of the protective cover 11. After that, at a rotation angle of +180° illustrated in FIG. 7C, the lock member 34 stops at a position where the lock member 34 bumps on the first rib 33a of the second tilt base 33 as illustrated in FIG. 8B.

Finally, the lens barrel 62 rotates in the CCW direction at the rotation angle stored in the firmware, and the sequence of the imaging direction adjustment is completed.

According to the configuration described above, in an imaging apparatus that includes a lens barrel and is capable of the imaging direction adjustment using an electrically driven motor, it is possible to retract a light-shielding member in a direction away from a protective cover, without upsizing of the imaging apparatus.

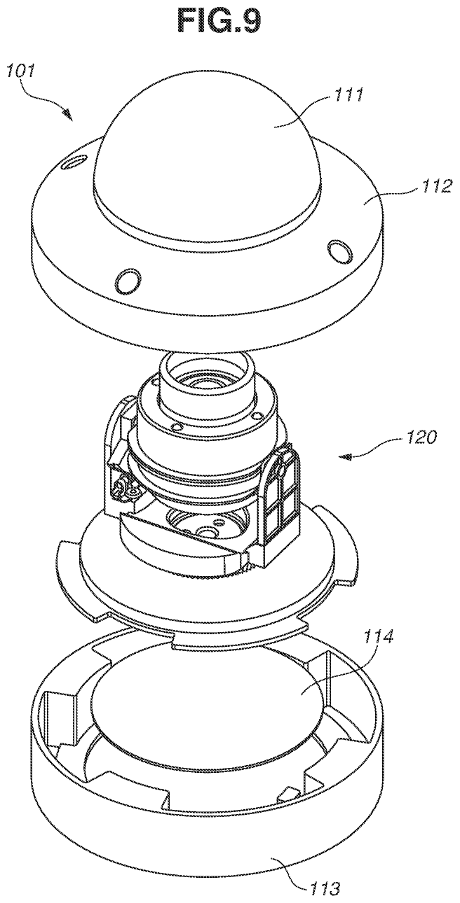

In a second exemplary embodiment, an imaging apparatus to which an exemplary embodiment which is different from the first exemplary embodiment is applied will be described. FIG. 9 is an exploded perspective view of an imaging apparatus 101.

The imaging apparatus 101 includes a protective cover 111, a housing including a top case 112 and a bottom case 113, a control circuit board 114, and an imaging unit 120.

The protective cover 111 protects the imaging unit 120 from, for example, rain drops, dust, and external impact. The protective cover 111 is a transparent member, such as polycarbonate and the like, and thus the imaging unit 120 can capture images from inside. The protective cover 111 is fixed to the top case 112.

The control circuit board 114 includes an image processing engine that processes imaging signals from the imaging unit 120, and a motor driver that generates drive signals to three motors for pan rotation, tilt rotation, and pivot rotation included in the imaging unit 120. The control circuit board 114 is fixed to the bottom case 113 and is connected to the imaging unit 120 via a cable not illustrated.

The imaging unit 120 includes a lens barrel 62 that has a lens group (not illustrated) and an imaging element (not illustrated). The imaging unit 120 supports the lens barrel 62 in such a manner that the lens barrel 62 can be moved with pan rotation, tilt rotation, and pivot rotation. The pivot rotation here refers to a rotation about an optical axis of the lens barrel 62, and the tilt rotation refers to a vertical rotation about an axis substantially orthogonal to the optical axis, and the pan rotation refers to a horizontal rotation about an axis substantially orthogonal to the central axis of the tilt rotation.

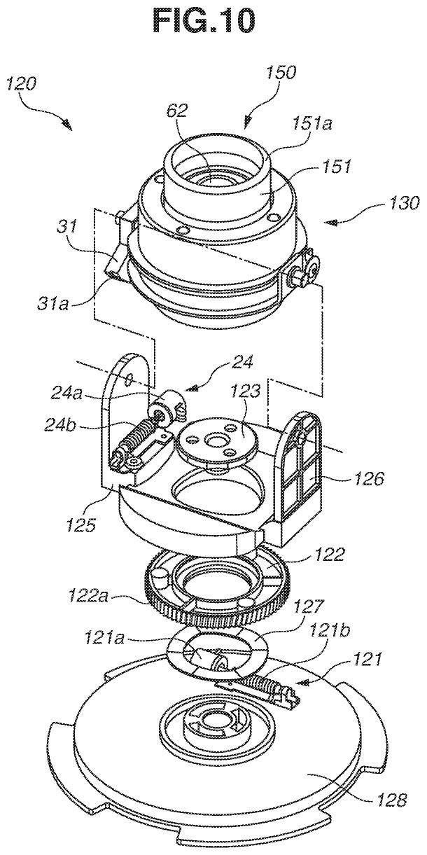

FIG. 10 is an exploded perspective view of the imaging unit 120. A tilt unit 130 is similar to the tilt unit 30 in the first exemplary embodiment except for the shape of a light-shielding member 151 of a light-shielding unit 150. The light-shielding member 151 is formed of an elastic member, such as rubber or thermoplastic elastomer, and has a substantially annular shape. When the protective cover 111 is attached, a close-contact surface 151a of the light-shielding member 151 comes in close contact with the inner surface of the protective cover 111.

The tilt unit 130 includes the lens barrel 62 and a tilt gear 31. The tilt unit 130 is supported by a pan base including a first pan base 125 and a second pan base 126 in such a manner that the tilt unit 130 can be moved with tilt rotation. A tilt motor unit 24, which is a drive mechanism for tilt rotation similar to that in the first exemplary embodiment, is arranged on the first pan base 125.

A pan gear 122 is fixed to the first pan base 125. A wave washer 127 is arranged between the pan gear 122 and a base member 128. A pan base press member 123 is fixed to the base member 128. The pan base press member 123 supports, together with the pan gear 122 receiving reaction force from the second pan base 126, the pan base including the first pan base 125 and the second pan base 126 in such a manner that the pan base can be moved with pan rotation.

A pan motor unit 121 includes a stepping motor 121a and a worm gear 121b, and is fixed to the base member 128. The worm gear 121b is press-fitted into an output shaft of a stepping motor 121a. The worm gear 121b and a helical gear 122a of the pan gear 122 engage with each other. Thus, the lens barrel 62 can be moved with pan rotation with the stepping motor 121a serving as a movement power source. That is, the pan motor unit 121 is a drive mechanism for pan rotation.

In the second exemplary embodiment, the light-shielding unit 150 is retracted downward to shift to a locked state, and then pan rotation, tilt rotation, and pivot rotation are performed by a method similar to that in the first exemplary embodiment. After that, the imaging direction is adjusted and the rotation angle after the adjustment is stored in the firmware. Then, the light-shielding unit 150 is unlocked by a method similar to that in the first exemplary embodiment. Finally, the light-shielding unit 150 rotates in the CCW direction up to the rotation angle stored in the firmware, and the sequence of the imaging direction adjustment is completed.

According to the configuration described above, in an imaging apparatus that includes a lens barrel and is capable of the imaging direction adjustment using an electrically driven motor, it is possible to retract a light-shielding member in a direction away from a protective cover, without upsizing of the imaging apparatus.

While, in the above-described exemplary embodiments, the retraction mechanism of the light-shielding unit is locked at the negative end of the operable range of pivot rotation, and is unlocked at the positive end of the operable range of pivot rotation, the present disclosure is not limited to this. For example, the retraction mechanism of the light-shielding unit can be locked and unlocked at reversed ends or at one end. Alternatively, regardless of positive and negative ends of pivot rotation, the retraction mechanism of the light-shielding unit can be configured such that the light-shielding unit is locked and unlocked when the mechanism rotates beyond the rotation angle settable range for the imaging direction adjustment.

In a case of an imaging direction adjustment by using pivot rotation without using shift movement, pan rotation, and tilt rotation, retracting the light-shielding unit can be omitted in terms of the imaging direction adjustment sequence. In this case, the range of rotation for unlocking the retraction mechanism of the light-shielding unit (+160° to +180° in the above-described exemplary embodiments) can be settable for the imaging direction adjustment.

Preferred exemplary embodiments of the present disclosure have been described above. However, the present disclosure is not limited to these exemplary embodiments and can be modified and changed in various manners without departing from the gist of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2022-087974, filed May 30, 2022, which is hereby incorporated by reference herein in its entirety.

What is claimed is:

1. An imaging apparatus comprising:
an imaging unit configured to have a lens barrel that is capable of rotation about an optical axis by a drive mechanism for rotation;
a cover configured to cover the imaging unit;
a light-shielding member configured to contact an inner surface of the cover; and
an illumination device configured to be disposed in a space covered with the cover,
wherein the light-shielding member is capable of retracting in a direction away from the cover by the drive mechanism.

2. The imaging apparatus according to claim 1,
wherein the lens barrel is capable of motor-operated rotation or movement around at least one predetermined axis different from the optical axis, and
wherein, before the lens barrel is moved with motor-operated rotation or movement around the predetermined axis, the light-shielding member is retracted in the direction away from the cover by the drive mechanism.

3. The imaging apparatus according to claim 1, wherein in a case where the lens barrel performs rotation beyond a preset rotation range, the light-shielding member retracts in the direction away from the cover.

4. The imaging apparatus according to claim 1, wherein in a case where the lens barrel is moved up to an end of a preset rotation range, the light-shielding member retracts in the direction away from the cover.

5. The imaging apparatus according to claim 1,
wherein the imaging unit has a lock member that keeps a state in which the light-shielding member is retracted from the cover, and
wherein, in a case where the lens barrel is moved with rotation beyond a preset rotation range, the lock member keeps the state in which the light-shielding member is retracted from the cover.

6. The imaging apparatus according to claim 5, wherein the light-shielding member kept in the state of being retracted from the cover by the lock member is released from the state of being retracted by the lens barrel being moved with rotation beyond the preset rotation range.

7. The imaging apparatus according to claim 1, wherein the imaging unit is capable of shift movement in a circumferential direction.

8. The imaging apparatus according to claim 3, wherein the imaging apparatus has a plurality of the imaging units that is arranged in a circumferential form.

9. The imaging apparatus according to claim 1, wherein the lens barrel is capable of pan rotation.

10. The imaging apparatus according to claim 1, wherein the lens barrel is capable of tilt rotation.

11. The imaging apparatus according to claim 1, wherein the illumination device is an infrared illumination device.

12. The imaging apparatus according to claim 1, wherein the imaging unit has a detection unit of a rotation angle of the lens barrel.
